(19) United States
(12) Patent Application Publication
(10) Pub. No.: US 2023/0412802 A1
(43) Pub. Date: Dec. 21, 2023

(54) METHOD AND APPARATUS FOR VIDEO CODING USING ARBITRARY BLOCK PARTITIONING

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/241,042

(22) Filed: Aug. 31, 2023

Related U.S. Application Data
(63) Continuation of application No. PCT/KR2022/003215, filed on Mar. 7, 2022.

(30) Foreign Application Priority Data
Mar. 8, 2021 (KR) 10-2021-0030285
Mar. 7, 2022 (KR) 10-2022-0028489

(51) Int. Cl. H04N 19/119; H04N 19/60; H04N 19/122; H04N 19/176; H04N 19/18; H04N 19/88; H04N 19/70; H04N 19/167; H04N 19/182

(52) U.S. Cl. CPC H04N 19/119; H04N 19/649; H04N 19/122; H04N 19/176; H04N 19/18; H04N 19/88; H04N 19/70; H04N 19/167; H04N 19/182

(57) ABSTRACT

A video coding method and an apparatus using arbitrary block partitioning are disclosed. The video coding method and apparatus perform a transform and an inverse transform on residual signals of arbitrary partitioned blocks when predicting a current block by using arbitrary block. Alternatively, the video coding method and the video coding apparatus perform a transform and an inverse transform on residual signals corresponding to some pixels adjacent to a partitioning boundary after an arbitrary partitioning of the current block.

### CROSS-REFERENCE TO RELATED APPLICATIONS

This application is a continuation of International Application No. PCT/KR2022/003215 filed on Mar. 7, 2022, which claims priority to Korean Patent Application No. 10-2021-0030285 filed on Mar. 8, 2021, and Korean Patent Application No. filed on Mar. 7, 2022, the entire disclosures of which are incorporated herein by reference.

### TECHNICAL FIELD

The present disclosure relates to a video coding method and an apparatus using arbitrary block partitioning.

### BACKGROUND

The statements in this section merely provide background information related to the present disclosure and do not necessarily constitute prior art.

Since video data has a large amount of data compared to audio or still image data, the video data requires a lot of hardware resources, including memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In a video encoding and decoding method and a video encoding and decoding apparatus, splitting a block into two or more subblocks is defined as block partitioning. Typically, in conventional video codecs, when partitioning a block into subblocks, it is divided into square or rectangular blocks. In contrast, a block can be partitioned into subblocks of arbitrary shape, which is called arbitrary block partitioning. Depending on the boundary characteristics of the objects in the frames constituting the video, arbitrary block partitioning may be more suitable than conventional square or rectangular block partitioning. Therefore, to improve the coding efficiency, arbitrary block partitioning needs to be considered.

### SUMMARY

The present disclosure in some embodiments seeks to a video coding method and an apparatus for performing a transform and an inverse transform on residual signals of arbitrary partitioned blocks when predicting a current block by using arbitrary block. Alternatively, the video coding method and the video coding apparatus perform a transform and an inverse transform on residual signals corresponding to some pixels adjacent to a partitioning boundary after an arbitrary partitioning of the current block.

At least one aspect of the present disclosure provides a method performed by a computing device for inverse transforming arbitrary partitioned blocks of a current block. The method comprises generating a reconstructed residual block by inverse transforming decoded transformed coefficients. The method also comprises obtaining arbitrary partitioning information of the current block. The arbitrary partitioning information represents a partitioning shape of the current block into the arbitrary partitioned blocks. The method also comprises determining, by using the arbitrary partitioning information, a relocation area for relocating residual signals of the reconstructed residual block within the current block. The method also comprises relocating the residual signals in the relocation area.

Another aspect of the present disclosure provides a block inverse transform device for inverse transforming arbitrary partitioned blocks of a current block. The device comprises an inverse transformer configured to generate a reconstructed residual block by inverse transforming decoded transformed coefficients. The device also comprises a partitioning information acquisition unit configured to obtain arbitrary partitioning information of the current block. The arbitrary partitioning information represents a partitioning shape of the current block into the arbitrary partitioned blocks. The device also comprises a relocation area determination unit configured to determine, by using the arbitrary partitioning information, a relocation area for relocating residual signals of the reconstructed residual block within the current block. The device also comprises a relocation unit configured to relocate the residual signals in the relocation area.

Yet another aspect of the present disclosure provides a method performed by a computing device for transforming arbitrary partitioned blocks of a current block. The method comprises obtaining arbitrary partitioning information of the current block. The arbitrary partitioning information represents a partitioning shape of the current block into the arbitrary partitioned blocks. The method also comprises determining, by using the arbitrary partitioning information, a transform area subject to a transform from the arbitrary partitioned blocks. The method also comprises generating a residual block by obtaining and two-dimensionally vectorizing residual signals of pixels included in the transform area. The method also comprises generating transformed coefficients of the current block by transforming the residual block.

As described above, the present disclosure provides a video coding method and an apparatus for performing a transform and an inverse transform on residual signals of arbitrary partitioned blocks when predicting a current block by using arbitrary block. Alternatively, the video coding method and the video coding apparatus perform a transform and an inverse transform on residual signals corresponding to some pixels adjacent to a partitioning boundary after an arbitrary partitioning of the current block, to improve an coding efficiency suitable for the characteristic of a frame constituting a video.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating arbitrary block partitioning using line segments, according to at least one embodiment of the present disclosure.

FIG. 7 is a diagram illustrating an arbitrary block partitioning based on a mask, according to at least one embodiment of the present disclosure.

FIG. 8 is a block diagram illustrating a block transform device for transforming arbitrary partitioned blocks, according to at least one embodiment of the present disclosure.

FIGS. 9A, 9B, 9C, and 9D are diagrams illustrating the selection of some pixels on an arbitrary partitioning boundary, according to at least one embodiment of the present disclosure.

FIG. 10 is a diagram illustrating the acquisition and transform of some pixels on an arbitrary partitioning boundary, according to at least one embodiment of the present disclosure.

FIG. 11 is a block diagram illustrating a block inverse transform device for inverse transforming arbitrary partitioned blocks, according to at least one embodiment of the present disclosure.

FIG. 12 is a diagram illustrating an inverse transform and relocation of some pixels on an arbitrary partitioning boundary, according to at least one embodiment of the present disclosure.

FIG. 13 is a diagram illustrating different transforms based on the locations of pixels on an arbitrary partitioning boundary, according to another embodiment of the present disclosure.

FIG. 14 is a diagram illustrating different inverse transforms based on the locations of pixels on an arbitrary partitioning boundary, according to another embodiment of the present disclosure.

FIG. 15 is a flowchart of a block transforming method for transforming arbitrary partitioned blocks, according to at least one embodiment of the present disclosure.

FIG. 16 is a flowchart of a block inverse transforming method for inverse transforming arbitrary partitioned blocks, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure have been omitted for the purpose of clarity and for brevity.

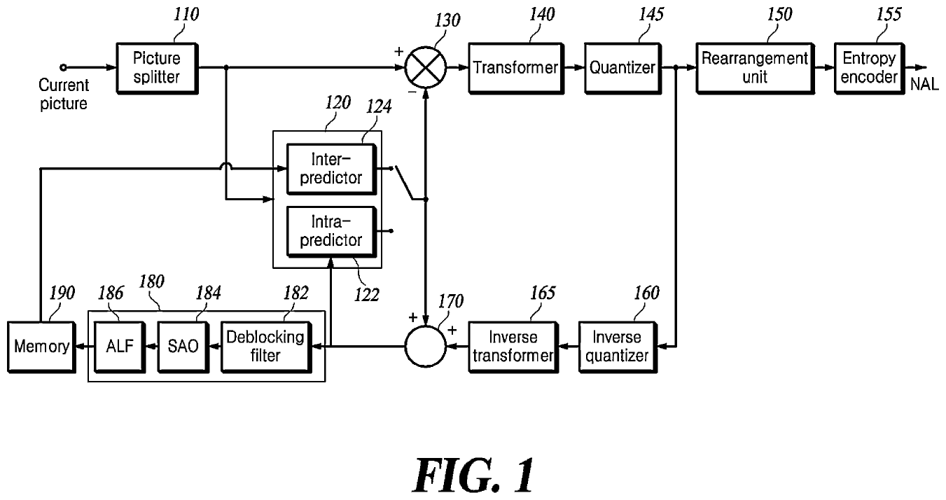

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

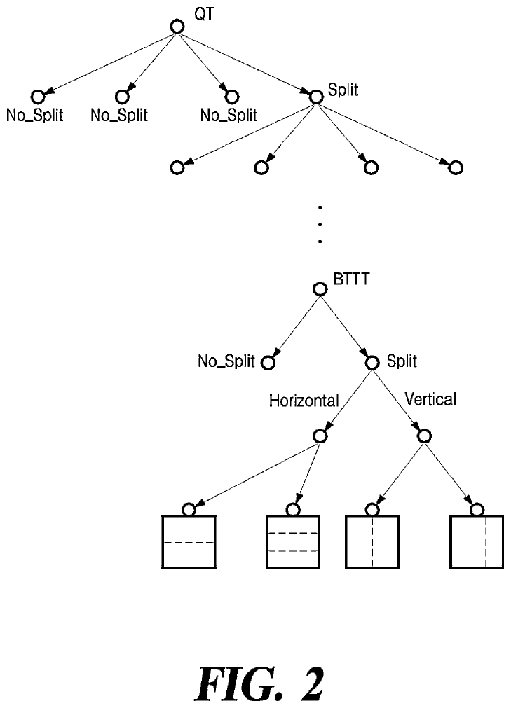

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

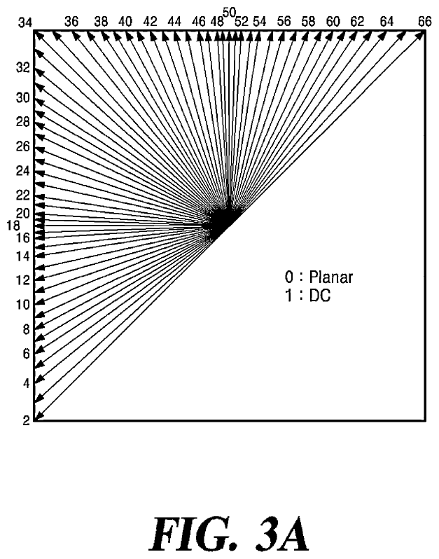

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-restored pictures, and reference picture list 1 may be constituted by pictures after the current picture in the display order among the pre-restored pictures. However, although not particularly limited thereto, the pre-restored pictures after the current picture in the display order may be additionally included in reference picture list 0. Inversely, the pre-restored pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

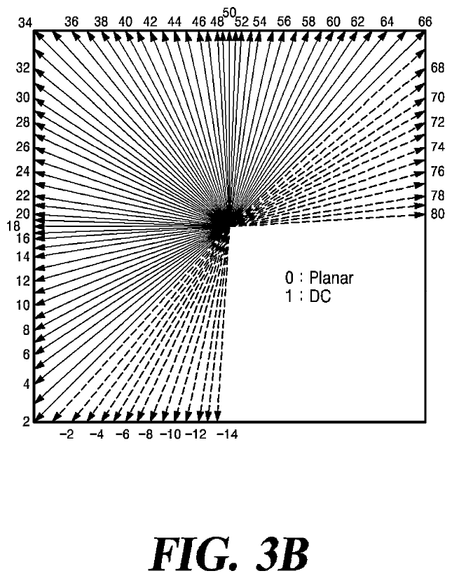

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain The transformer 140 may transform residual signals in the residual block by using a total size of the residual block as a transform unit or also split the residual block into a plurality of subblocks and perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to transform coefficients quantized arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient

sequence by using coefficient scanning For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to restore the residual block.

The adder 170 adds the restored residual block and the prediction block generated by the predictor 120 to restore the current block. Pixels in the restored current block may be used as reference pixels when intra-predicting a next-order block.

The loop filter unit 180 performs filtering for the restored pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the restored blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the restored pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The restored block filtered through the deblocking filter 182, the SAO filter 184, and the ALF 186 is stored in the memory 190. When all blocks in one picture are restored, the restored picture may be used as a reference picture for inter predicting a block within a picture to be encoded afterwards.

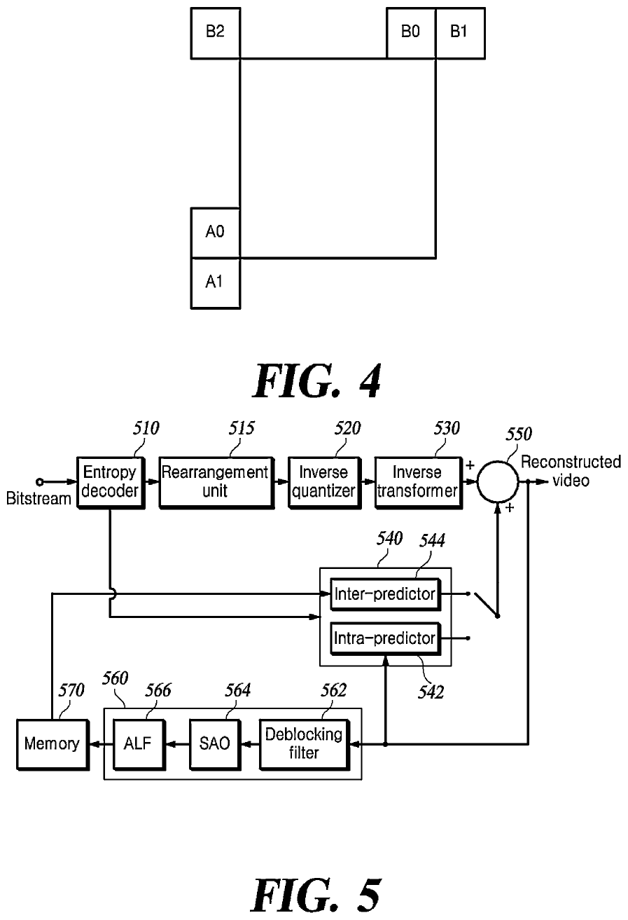

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to restore the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 restores the current block by adding the residual block output from the inverse transformer 530 and the prediction block output from the inter predictor 544 or the intra predictor 542. Pixels within the restored current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the restored blocks in order to remove the blocking artifact, which occurs due to block unit decoding. The SAO filter 564 and the ALF 566 perform additional filtering for the restored block after the deblocking filtering in order to compensate differences between the restored pixels and original pixels, which occur due to lossy coding. The filter coefficients of the ALF are determined by using information on filter coefficients decoded from the bitstream.

The restored block filtered through the deblocking filter 562, the SAO filter 564, and the ALF 566 is stored in the memory 570. When all blocks in one picture are restored, the restored picture may be used as a reference picture for inter predicting a block within a picture to be encoded afterwards.

The present disclosure in some embodiments relates to encoding and decoding video images as described above. More specifically, the present disclosure provides a video coding method and an apparatus that, when predicting a current block by using arbitrary block partitioning, perform transforming and inverse transforming on residual signals of arbitrary partitioned blocks. Alternatively, the video coding method and the video coding apparatus perform transforming and inverse transforming on residual signals corresponding to some pixels adjacent to partition boundaries after arbitrary partitioning of the current block.

The following embodiments may be applied to the picture splitter 110, the predictor 120, the transformer 140, and the inverse transformer 165 in the video encoding apparatus. The following embodiments may also be applied to the inverse transformer 530 and predictor 540 in the video decoding apparatus.

In the following descriptions, the term ‘target block’ to be encoded/decoded may be used interchangeably with the current block or coding unit (CU) as described above, or the term ‘target block’ may refer to some area of the coding unit.

Hereinafter, partitioning a target block into lower-level subblocks of arbitrary shape is referred to as arbitrary block partitioning or arbitrary partitioning. Further, the partitioned subblocks are referred to as arbitrary partitioned blocks.

### I. Arbitrary Block Partitioning Using Line Segments

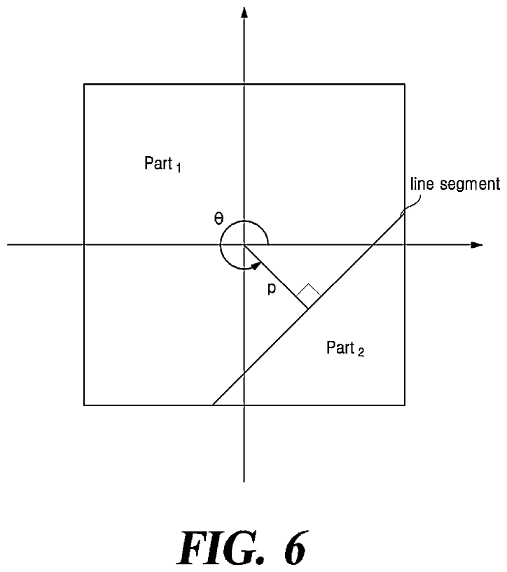

FIG. 6 is a diagram illustrating arbitrary block partitioning using line segments, according to at least one embodiment of the present disclosure.

In the example of FIG. 6, the current block may be a square or rectangular block. The picture splitter 110 in the video encoding apparatus may recursively split these square or rectangular blocks into various tree forms. As described above, the picture splitter 110 may split the current block into subblocks based on such structures as quadtrees, binary trees, ternary trees, and the like.

Furthermore, the picture splitter 110 may split the current block into two different arbitrary partitioned blocks by using a line segment having a specific angle 0 and distance p from the origin of the block, as illustrated in FIG. 6. In this case, the video encoding apparatus may signal to the video decoding apparatus the angle and distance relative to the origin on a per block as parameters for representing the line segment. Alternatively, the video encoding apparatus may signal a specific index value generated by combining the angle and distance.

Meanwhile, the origin of the block may be a geometrical center. For example, for a square or rectangular block, the origin of the block may be the intersection of a straight line vertically bisecting a lateral side of the block and a straight line vertically bisecting a bottom side of the block.

The following describes a method and apparatus for transforming/inverse transforming only some of the residual signals in an arbitrary partitioned block. Also described are a method and an apparatus for transforming/inverse transforming residual signals in an arbitrary partitioned block into a plurality of residual subblocks and then transforming/inverse transforming each subblock differently.

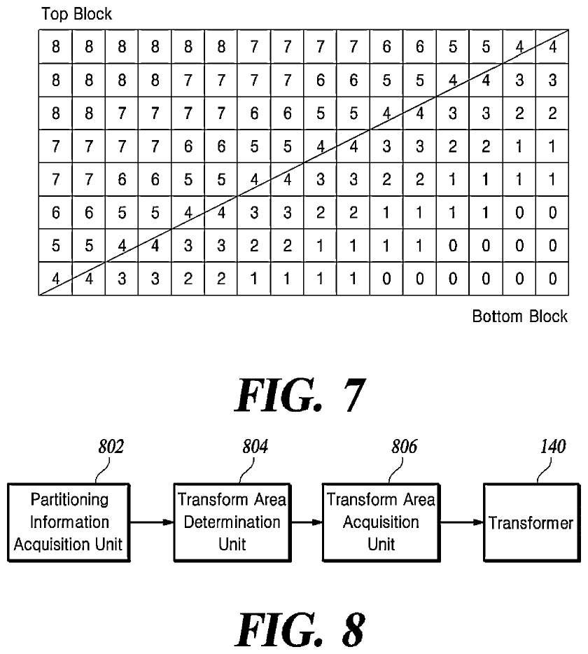

FIG. 7 is a diagram illustrating mask-based arbitrary block partitioning, according to at least one embodiment of the present disclosure.

In other embodiments, the picture splitter 110 may perform mask-based arbitrary block partitioning. For example, the picture splitter 110 may arbitrarily partition the current block by applying different weights based on pixel location. In the illustration of FIG. 7, for example, the weight may have a value of 0 to 8. Further, for pixels in adjacent areas relative to the arbitrary partitioning line segment, the weight of the pixels may be decreased or increased depending on the distance from the partition line segment. For example, in case of the top block, the picture splitter 110 may arbitrarily split the top block from the current block by using the weights by applying the largest weight of 8 to the pixels adjacent to the upper left corner of the current block, applying a medium weight of 4 to the pixels adjacent to the boundary line segment, and applying the smallest weight of 0 to the pixels near the lower right corner. Additionally, the picture splitter 110 may reverse the applications of weights to arbitrary split the bottom block from the current block.

The reason for applying different weights relative to the arbitrary partitioning line segment is due to the statistical property that large residual signals occur in pixels near the arbitrary partitioning line segment. Therefore, by using different weights based on the distance from the arbitrary partitioning line segment, the boundary deterioration that may occur at the boundary of the arbitrary block partitioning can be reduced.

### II. Transform of Arbitrary Partitioned Blocks

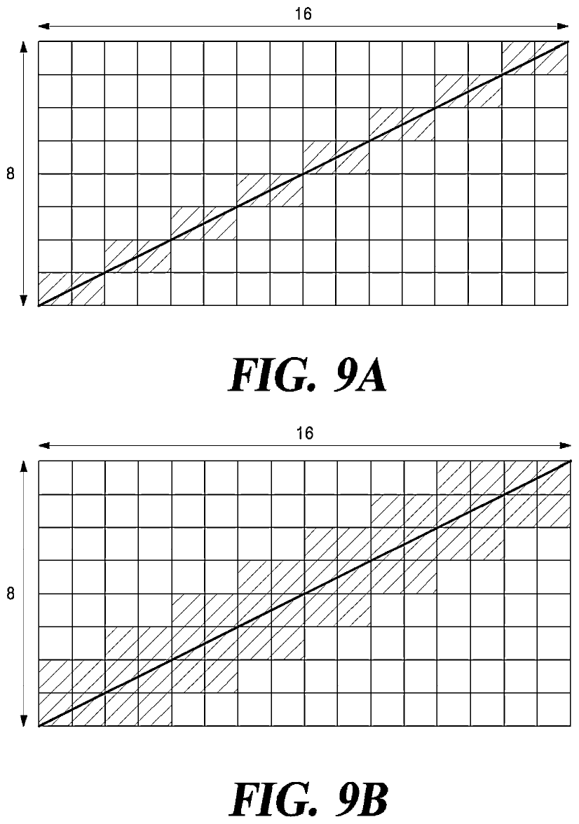

FIG. 8 is a block diagram illustrating a block transform device for transforming arbitrary partitioned blocks, according to at least one embodiment of the present disclosure.

The block transform device according to the present embodiment transforms only some of the residual signals in the arbitrary partitioned blocks. The block transform device includes all or part of a partitioning information acquisition unit 802, a transform area determination unit 804, a transform area acquisition unit 806, or the transformer 140. The partitioning information acquisition unit 802, transform area determination unit 804, and transform area acquisition unit 806 in the block transform device correspond to preprocessing steps for the transform and are described separately for convenience. However, the partitioning information acquisition unit 802, transform area determination unit 804, and transform area acquisition unit 806 may be included as part of the transformer 140. Thus, the block transform unit may be included in the transformer 140 in the video encoding apparatus.

The partitioning information acquisition unit 802 acquires arbitrary partitioning information of the current block, i.e., the partitioning information acquisition unit 802 may derive or parse information on how the current block is divided into certain shapes of arbitrary partitioned blocks. Here, the current block may be a single square or rectangular block, and the arbitrary partitioned blocks may not be square and rectangular.

In one example, the arbitrary partitioning information is information indicating when the current block is bisected utilizing a single line segment. For this shape of partitioning, the arbitrary partitioning information may be signaled from a higher level by using one or more syntaxes. The partitioning information acquisition unit 802 may acquire the arbitrary partitioning information by parsing the signaled syntax or by deriving the arbitrary partitioning information from the syntax. The arbitrary partitioning information may include the angle and distance of the partitioning line segment relative to the origin of the current block, as described above. In addition, the arbitrary partitioning information may include a single index value obtained by combining the angle and distance of the partitioning line segment relative to the origin.

As another example, the arbitrary partitioning information may be information indicating the occasion of bisecting or further partitioning the current block by utilizing one or more line segments.

In another example, the pixels in the current block may be residual signals obtained by subtracting the signal predicted by the predictor 120 from the original signal.

The transform area determination unit 804 determines the transform area subject to the transform by using the arbitrary partitioning information. At this time, the transform area including the pixels to be transformed may be determined differently according to the arbitrary partitioning information. For example, the transform area determination unit 804 may use predefined pixels as the transform area according to the partitioning shape of the current block. Alternatively, the transform area determination unit 804 may determine the pixels to be transformed based on the boundaries of an arbitrary partitioning. To conclude, the transform area determination unit 804 may select, from among pixels in the current block, the pixels located on the boundary of the arbitrary partitioning and may select the pixels spatially adjacent to the boundary as the transform area.

The transform area acquisition unit 806 acquires and vectorizes the residual signals of the target pixels determined to be the transform area to generate a residual block. Since the residual block is generated from the transform area, the size of the encoding target block may be different from the size of the residual block. The generated residual block is transferred to the transformer 140.

The transformer 140 transforms the delivered residual block to generate the transformed coefficients of the current block.

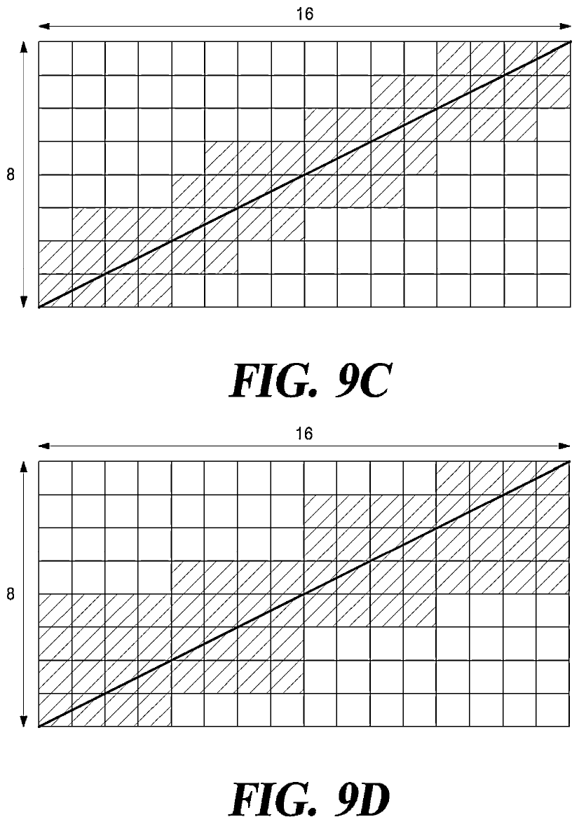

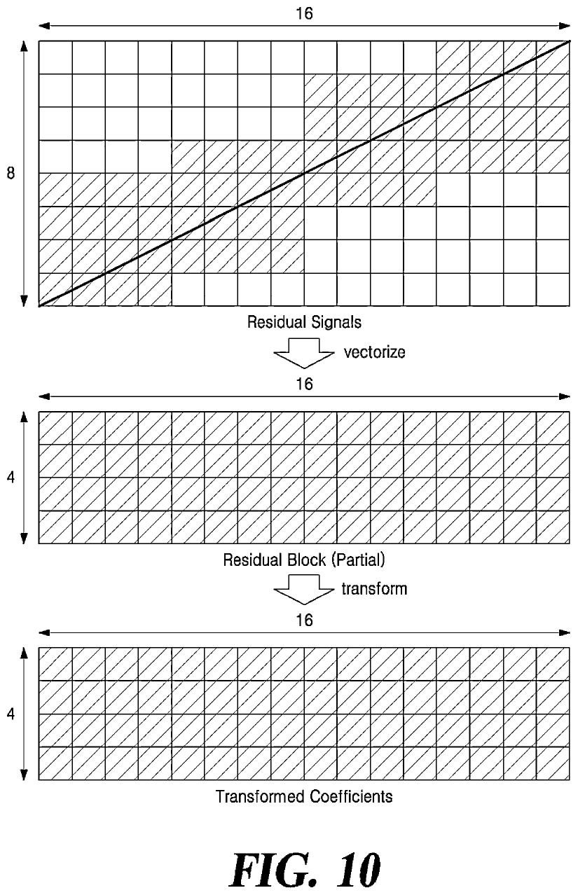

Hereinafter, using the examples of FIGS. 9A, 9B, 9C, and 9D and FIG. 10, a method of determining a transform area and a method of acquiring pixels in the transform area is described.

FIGS. 9A, 9B, 9C, and 9D are diagrams illustrating the selection of some pixels on an arbitrary partitioning boundary, according to at least one embodiment of the present disclosure.

As an example, in the illustrations of FIGS. 9A, 9B, 9C, and 9D, a current block of size 16×8 is arbitrarily partitioned into two triangular blocks by a line segment connecting the bottom left and top right.

The example of FIG. 9A illustrates pixels located at the boundary of an arbitrary block partitioning. The transform area determination unit 804 may select just the pixels located at the boundary of the arbitrary partitioning and may determine those pixels as a transform area, as shown in the illustration of FIG. 9A. Then, the transform area acquisition unit 806 may vectorize the pixels located on the boundary of the arbitrary partitioning. For example, the transform area acquisition unit 806 may vectorize the 16 pixels located at the arbitrary partitioning boundary into a one-dimensional (1D) vector of 16×1 or 1×16 or into a two-dimensional (2D) vector of 4×4, 8×2, or 2×8.

In another embodiment as shown in FIG. 9B, the transform area determination unit 804 may determine the transform area up to the top, bottom, left, and right pixels based on the pixels located on the boundary of the arbitrary block partitioning. For example, the transform area determination unit 804 may select the pixels located at the boundary of the arbitrary partitioning and may select the pixels at the x+1, x−1, y+1, and y−1 positions relative to the boundary as the transform area.

Meanwhile, in the example of FIG. 9B, the total number of pixels to be transformed in the transform area is 44, which includes a factor that is not a multiple of 2. Therefore, if the target pixels are composed of a two-dimensional vector of size 4×11, the target pixels may be difficult to connect with components of a conventional video coding device.

In yet another embodiment as shown in FIG. 9C, the transform area determination unit 804 may set the total number of transform target pixels included in the transform area to a number that is easy to transform, such as a multiple of 8 or 16. When the transform area determination unit 804 selects certain pixels based on the boundary of the arbitrary block partitioning, the transform area determination unit 804 may adjust the number of target pixels so that the number of pixels is suitable for the subsequent transform. For example, in the illustration of FIG. 9C, the number of target pixels is 48, and the transform area acquisition unit 806 may vectorize the target pixels into a 2D vector of size 16×3 or 8×6.

As described above, when a video coding method and apparatus perform pixel-by-pixel processing, the complexity of memory access and computation may increase. Therefore, to address these issues, target pixels may be selected on a subblock basis. In yet another embodiment as shown in FIG. 9D, the transform area determination unit 804 may partition the pixels located on the boundary of the arbitrary block partitioning into 4×4 subblocks. Then, using a total of four 4×4 blocks, the transform area acquisition unit 806 may vectorize them into a 16×4 block for transform.

The transform area determination unit 804 may further select the target pixels for the transform per 8×8 block or 16×16 block basis.

FIG. 10 is a diagram illustrating the acquisition and transform of some pixels on an arbitrary partitioning boundary, according to at least one embodiment of the present disclosure.

In at least one embodiment, FIG. 10 is an example where a current block of size 16×8 is arbitrarily divided into two triangular blocks by a line segment connecting the bottom left and top right. As mentioned above, the pixels in the current block may be residual signals obtained by subtracting the signals predicted by the predictor 120 from the original signals. Accordingly, FIG. 10 illustrates a process for transforming, by using such arbitrarily partitioned two triangular blocks, residual signals corresponding to some pixel locations adjacent to the boundary of the arbitrary block partitioning.

For the two arbitrary partitioned triangular blocks, the transform area determination unit 804 determines the pixels located on the boundary of the arbitrary partitioning and the pixels adjacent to the boundary as the transform area. As the illustration of FIG. 10, for a plurality of pixels adjacent to the line segment connecting the bottom left and top right, the transform area determination unit 804 may determine the pixels corresponding to a total of four 4×4 blocks as the transform area.

The transform area acquisition unit 806 acquires and vectorizes the residual signals of the pixel positions in the transform area. As the illustration of FIG. 10, the transform area acquisition unit 806 may two-dimensionally vectorize the four 4×4 blocks described above into a single 16×4 residual block and then may transfer the generated residual block to the transformer 140. Alternatively, the transform area acquisition unit 806 may two-dimensionally vectorize the four 4×4 blocks into a single 4×16 residual block and then may transfer the generated residual block to the transformer 140.

Meanwhile, the example of FIG. 10 illustrates, but is not necessarily limited to, acquiring and two-dimensionally vectorizing residual signals of some pixel locations adjacent to the boundary of the arbitrary partitioning, from the current block of size 16×8. For example, the transform area determination unit 804 and the transform area acquisition unit 806 may determine a transform area that is expanded or contracted by various sizes, without limitation to the positions of some pixels described above and may acquire and two-dimensionally vectorize residual signals of pixels in such a transform area.

The transformer 140 transforms the transmitted residual signals to generate the transformed coefficients. At this time, the size of the target block to be encoded may be different from the size of the residual block to be transformed, as discussed above. For example, as illustrated in FIG. 10, the target block may be a 16×8-block, but the residual block on which the transform is performed is a 16×4-block, making the target block to be encoded different in size from the residual block.

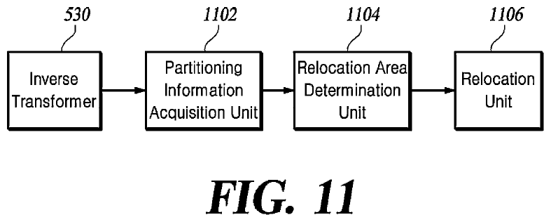

FIG. 11 is a block diagram illustrating a block inverse transform device for inverse transforming arbitrary partitioned blocks, according to at least one embodiment of the present disclosure.

The block inverse transform device according to this embodiment inversely transforms just a portion of the residual signals in the arbitrary partitioned blocks. The block inverse transform device includes all or part of an inverse transformer 530, a partitioning information acquisition unit 1102, a relocation area determination unit 1104, and a relocation unit 1106. The partitioning information acquisition unit 1102, the relocation area determination unit 1104, and the relocation unit 1106 in the block inverse transform device correspond to post-processing steps for the inverse transform and are described separately for convenience but may be included as part of the inverse transformer 530. Thus, the block inverse transform device may be included in the inverse transformer 530 in the video decoding apparatus.

The inverse transformer 530 inversely transforms the transformed coefficients decoded from the bitstream to generate a reconstructed residual block of the current block. At this time, the inverse transformer 530 may perform the inverse transforming by using a predefined transform method. Alternatively, the inverse transformer 530 may utilize the inverse transform information signaled for the block to be decoded but may perform the inverse transform by using one or more of a plurality of inverse transform methods. Additionally, as described above, the size of the block to be decoded may be different from the size of the inverse transformed residual block.

The partitioning information acquisition unit 1102 acquires arbitrary partitioning information of the current block. For example, the partitioning information acquisition unit 1102 may derive or parse information from the decoded syntax about how the current block is partitioned into arbitrary partitioned blocks of certain shapes. Here, the current block may be a single square or rectangular block, and the arbitrary partitioned blocks may not be square and rectangular.

In one example, the arbitrary partitioning information is information indicating when the current block is bisected by utilizing a single line segment. The arbitrary partitioning information may include an angle and distance of the partitioning line segment relative to the origin of the current block. Alternatively, the arbitrary partitioning information may include a single index value obtained by combining the angle and distance of the partitioning line segment relative to the origin.

As another example, the arbitrary partitioning information may be information indicating the occasion of bisecting or further partitioning the current block by utilizing one or more line segments.

The relocation area determination unit 1104 uses the arbitrary partitioning information to determine a relocation area for relocating the residual signals of the reconstructed residual block within the current block. Depending on the arbitrary partitioning information, pixels in the current block to which the reconstructed residual signals are relocated may be selected differently. For example, the relocation area determination unit 1104 may use as the relocation area the pixels predefined according to the partitioning shape of the current block. Alternatively, the relocation area determination unit 1104 may determine the pixels to be relocated based on the boundaries of an arbitrary partitioning. In conclusion, the relocation area determination unit 1104 determines, as the relocation area, the pixels located on the boundary of the arbitrary partitioning and the pixels adjacent to the boundary.

The relocation unit 1106 relocates the reconstructed residual signals to a determined relocation area.

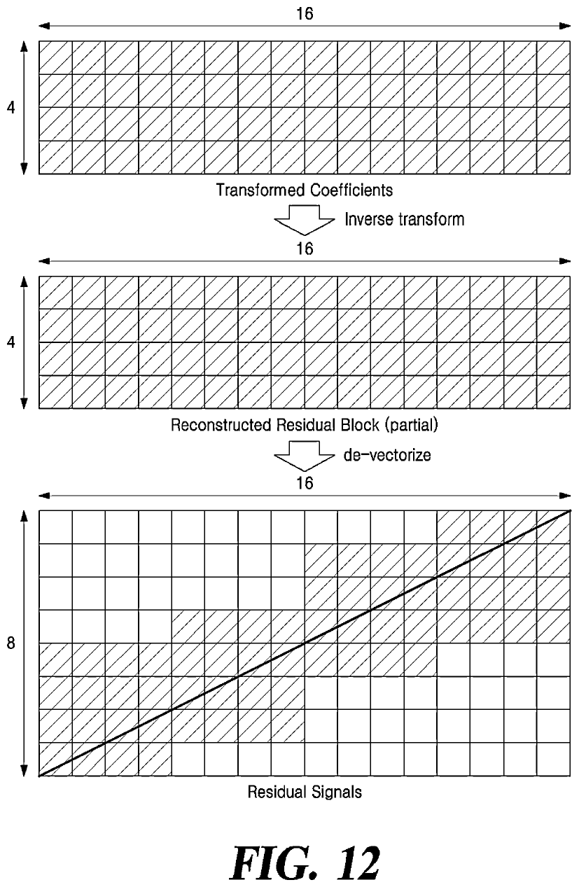

FIG. 12 is a diagram illustrating an inverse transform and relocation of some pixels of an arbitrary partitioning boundary, according to at least one embodiment of the present disclosure.

In at least one embodiment, FIG. 12 is an example of a current block of size 16×8 being arbitrarily partitioned into two triangular blocks by a line segment connecting the bottom left and top right. Further, FIG. 12 illustrates a process of using these two arbitrary partitioned triangular blocks for inverse transforming residual signals corresponding to some pixel locations adjacent to the boundary of the arbitrary block partitioning. On the other hand, the example of FIG. 12 illustrates the inverse process of the example of FIG. 10, which is the case of arbitrarily partitioning the current block into two triangular blocks.

In the example of FIG. 12, for a block of size 16×4, the inverse transformer 530 performs an inverse transform to generate a reconstructed residual block. At this time, as described above, the size of the block to be decoded may be different from the size of the residual block subject to the inverse transform. For example, as illustrated in FIG. 12, the target block may be a 16×8-block, but the residual block on which the inverse transform is performed is a 16×4-block, making the target block to be decoded different in size from the residual block.

If the reconstructed residual block is part of the pixels in the current block that are arbitrarily partitioned, the relocation area determination unit 1104 and the relocation unit 1106 generate the entire residual block of the current block from the reconstructed residual block based on the arbitrary partitioning information. In the illustration of FIG. 12, the relocation area determination unit 1104 and the relocation unit 1106 relocate the residual signals in the residual block of size 16×4 to the boundary of the arbitrary block partitioning to generate the entire residual signals of the current block of size 16×8. On the other hand, for a pixel location that is not adjacent to the boundary of the arbitrary partitioning, the relocation unit 1106 may set a predefined value. Here, the predefined value may be, for example, 0 (zero). Subsequently, the relocated entire residual signals and the signals predicted by the predictor 540 may be summed, thereby generating reconstructed signals of the current block.

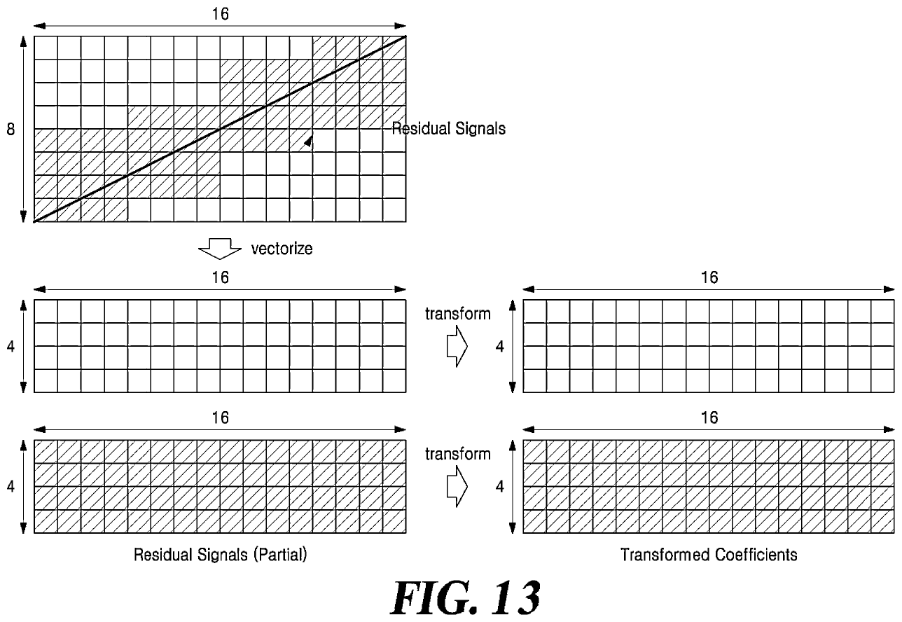

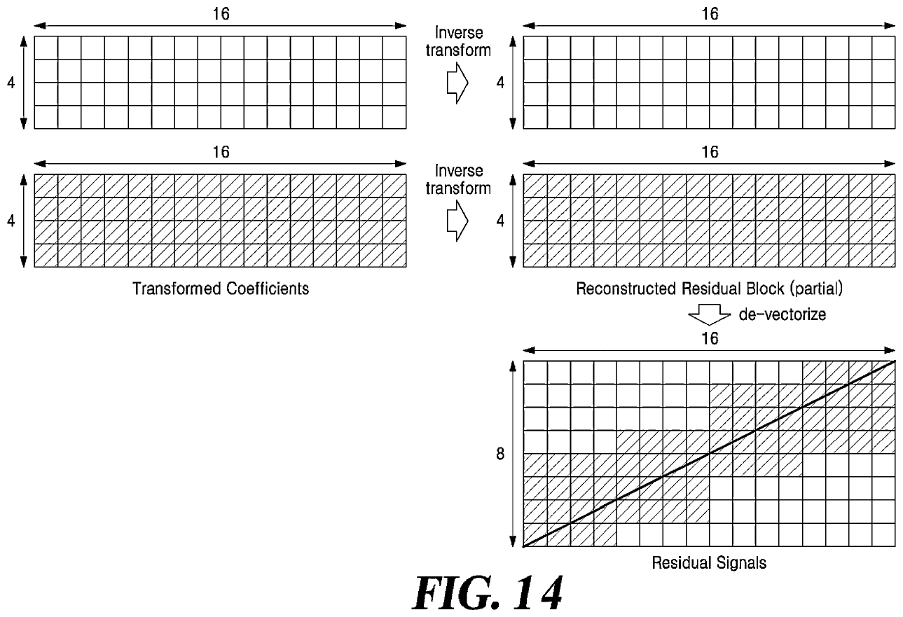

Hereinafter, as other embodiments, the illustrations of FIGS. 13 and 14 are used in transforming/inverse transforming the entire residual signals of the current block to describe examples of applying a different transforming/inverse transforming method based on the locations of pixels on a boundary of an arbitrary block partitioning.

FIG. 13 is a diagram illustrating different transforms based on the locations of pixels on an arbitrary partitioning boundary, according to another embodiment of the present disclosure.

In at least one embodiment, FIG. 13 is an example of a current block of size 16×8 arbitrarily partitioned into two triangular blocks by a line segment connecting the bottom left and top right. As mentioned above, the pixels in the current block may be residual signals obtained by subtracting the signals predicted by the predictor 120 from the original signals. Accordingly, FIG. 13 illustrates a process for transforming, by using such arbitrarily partitioned two triangular blocks, residual signals differently depending on the locations of pixels adjacent to the boundary of the arbitrary block partitioning.

For the two arbitrarily divided triangular blocks, the transform area determination unit 804 determines the pixels on the boundary of the arbitrary partitioning as the first transform area. Further, the transform area determination unit 804 may determine the remaining pixels in the two triangular blocks excluding the first transform area as the second transform area. As the illustration of FIG. 13, for a plurality of pixels adjacent to the line segment connecting the bottom left and top right, the transform area determination unit 804 may designate pixels corresponding to a total of four 4×4 blocks as the first transform area. Further, the transform area determination unit 804 may designate 16×4 pixels excluding the first transform area, i.e., pixels located at spatially far distances from the block partitioning boundary, as the second transform area.

The transform area acquisition unit 806 generates subblocks by vectorizing the residual signals at the pixel locations in the first transform area and the second transform area. As the illustration of FIG. 13, the transform area acquisition unit 806 may two-dimensionally vectorize the four 4×4 blocks included in the first transform area into a single 16×4-sized first residual block and may further two-dimensionally vectorize the four 4×4 blocks included in the second transform area into a single 16×4-sized second residual block. The generated first residual block and second residual block, i.e., subblocks, may be transferred to transformer 140.

The transformer 140 may apply a different transform to each of the subblocks to generate the transformed coefficients of the current block.

FIG. 14 is a diagram illustrating different inverse transforms based on the locations of pixels on the boundary of an arbitrary partitioning, according to another embodiment of the present disclosure.

In at least one embodiment as illustrated in FIG. 14, a current block of size 16×8 is arbitrarily split into two triangular blocks by a line segment connecting the bottom left and top right. Further, FIG. 14 illustrates a process of using these two arbitrarily divided triangular blocks to inversely transform the residual signals differently depending on the locations of pixels adjacent to the boundary of the arbitrary partitioning. On the other hand, the example of FIG. 14 illustrates the reverse process of the example of FIG. 13, which is the case of arbitrarily dividing the current block into two triangular blocks.

When there are two subblocks corresponding to the current block, the inverse transformer 530 performs different inverse transforms on each subblock to generate an inverse-transformed first residual block and an inverse-transformed second residual block. As the illustration of FIG. 14, when the block to be decoded is a 16×8-block, the inverse transformer 530 performs different inverse transforms on the transformed coefficient blocks corresponding to the two 16×4 subblocks to generate an inverse transformed first residual block and an inverse transformed second residual block. Here, the first residual block and the second residual block are both blocks of size 16×4. The first residual block includes the residual signals in the first transform area, which includes a plurality of pixels adjacent to the boundary of the arbitrary block partitioning. The second residual block includes the residual signals in the second transform area, which includes the remaining pixels excluding the first transform area.

The relocation area determination unit 1104 and the relocation unit 1106 relocate the first residual block and the second residual block based on the arbitrary partitioning information of the current block to generate the entire residual signals of the current block. As the illustration of FIG. 14, the relocation area determination unit 1104 and the relocation unit 1106 relocate the first residual block of size 16×4 to the first transform area adjacent to the boundary of the arbitrary block partitioning and relocate the second residual block of size 16×4 to the second transform area. Subsequently, the relocated entire residual signals and the signals predicted by the predictor 540 may be summed, and thus reconstructed signals of the current block may be generated.

In the examples of FIGS. 13 and 14, two subblocks are utilized, but the present disclosure is not necessarily limited thereto. In another embodiment, the block transforming/inverse transform device may partition the current block into two or more subblocks based on the distance from the boundary of the arbitrary block partitioning and then may apply different transforming/inverse transforming to the partitioned subblocks. At this time, the size of the subblocks that are divided according to the distance from the boundary of the arbitrary block partitioning may be equal or different. For example, in the illustrations of FIGS. 13 and 14, a 16×8 block may be equally divided into two 16×4 subblocks, but in another example, a 16×8 block may be differentially divided into a 16×2 subblock and a 16×6 subblock. Alternatively, the 16×8 block may be evenly divided into four 16×2 subblocks.

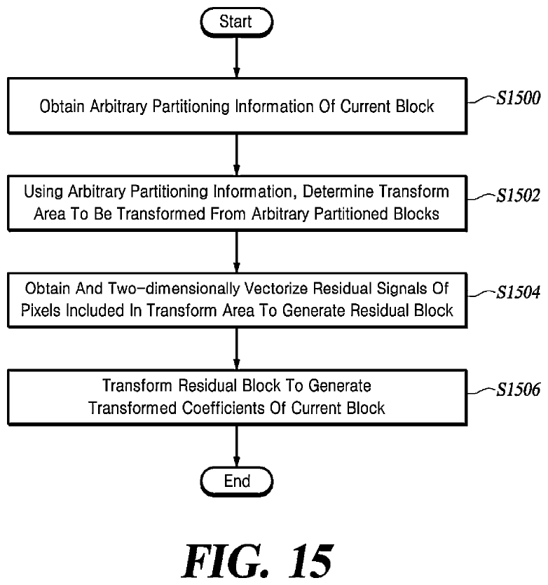

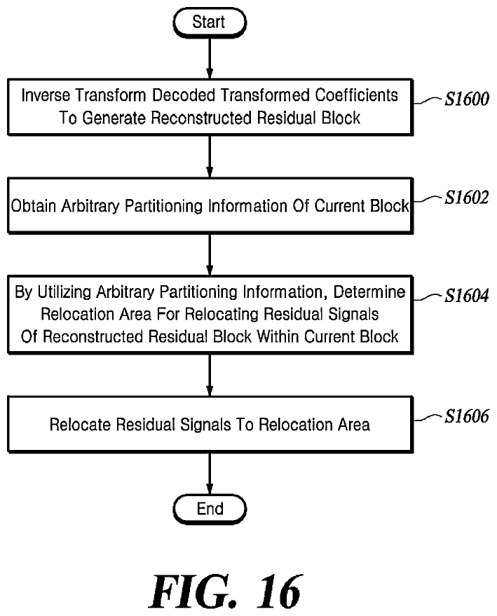

The following describes, with reference to FIGS. 15 and 16, a method of transforming/inverse transforming arbitrary partitioned blocks, performed by a block transforming/inverse transforming device.

FIG. 15 is a flowchart of a block transforming method for transforming arbitrary partitioned blocks, according to at least one embodiment of the present disclosure.

The block transform device obtains arbitrary partitioning information of the current block (S1500). Here, the arbitrary partitioning information is information indicating that the current block is partitioned into arbitrary partitioned blocks of certain shapes.

The block transform device may derive or parse the arbitrary partitioning information by using a syntax signaled from a high level. In this case, the current block may be a single square or rectangular block, and the arbitrary partitioned blocks may be non-square and non-rectangular.

In one example, the arbitrary partitioning information is information indicating the occurrence of bisecting the current block by utilizing a single line segment. The arbitrary partitioning information may include an angle and distance of the partition line segment relative to the origin of the current block, as described above. Alternatively, the arbitrary partitioning information may include a single index value obtained by combining the angle and distance of the partitioning line relative to the origin.

Meanwhile, the pixels in the current block may be residual signals obtained by subtracting signals predicted by the predictor 120 from the original signals.

The block transform device determines, by using the arbitrary partitioning information, a transform area subject to the transform from the arbitrary partitioned blocks (S1502). At this time, the transform area including the pixels subject to the transform may be determined differently according to the arbitrary partitioning information. In other words, the block transform device may use the pixels predefined according to the partitioning form of the current block, as the transform area. Alternatively, the block transform device may determine, based on the boundary of an arbitrary partitioning, the pixels subject to the transform. As a result, the block transform device may select, from among the pixels in the current block, pixels located on the boundary of the arbitrary partitioning and pixels spatially adjacent to the boundary, as the transform area.

The block transform device obtains and two-dimensionally vectorizes the residual signals of the pixels included in the transform area to generate a residual block (S1504). Since the residual block is generated from the transform area, the size of the current block may be different from the size of the residual block.

The block transform device transforms the residual block to generate the transformed coefficients of the current block (S1506).

FIG. 16 is a flowchart of a block inverse transforming method for inverse transforming arbitrary partitioned blocks, according to at least one embodiment of the present disclosure.

The block inverse transform device inversely transforms the decoded transformed coefficients to generate a reconstructed residual block (S1600). The block inverse transform device may perform the inverse transforming by using a predefined transform method. Additionally, as described above, the size of the decoding target block may be different from the size of the inverse transformed residual block.

The block inverse transforming device obtains arbitrary partitioning information of the current block (S1602). Here, the arbitrary partitioning information is information indicating that the current block is partitioned into arbitrary partitioned blocks of certain shapes. The block inverse transforming device may derive or parse the arbitrary partitioning information by using the decoded syntax. In this case, the current block may be a single square or rectangular block, while the arbitrary partitioned blocks may not be square and rectangular. In one example, the arbitrary partitioning information is information indicating the occurrence of bisecting the current block by utilizing a single line segment.

The block inverse transform device uses the arbitrary partitioning information to determine a relocation area for relocating the residual signals of the reconstructed residual block within the current block (S1604). Depending on the arbitrary partitioning information, pixels in the current block to which the reconstructed residual signals are relocated may be selected differently. In other words, the block inverse transform device may use predefined pixels according to the partitioning shape of the current block, as the relocation area. Alternatively, the block inverse transforming device may determine the pixels to be relocated based on the boundaries of arbitrary partitioning. In conclusion, the block inverse transform device determines, from among the pixels in the current block, the pixels located on the boundary of the arbitrary partitioning and the pixels adjacent to the boundary, as the relocation area.

The block inverse transform device relocates the residual signals to the relocation area (S1606).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “. . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

(Reference Numerals)
140: transformer
530: inverse transformer
802: partitioning information acquisition unit
804: transform area determination unit
806: transform area acquisition unit
1102: partitioning information acquisition unit
1104: relocation area determination unit
1106: relocation unit

What is claimed is:

1. A method performed by a video decoding apparatus for inverse transforming arbitrary partitioned blocks of a current block, the method comprising:
generating a reconstructed residual block by inverse transforming decoded transformed coefficients;
obtaining arbitrary partitioning information of the current block, wherein the arbitrary partitioning information represents a partitioning shape of the current block into the arbitrary partitioned blocks;
determining, by using the arbitrary partitioning information, a relocation area for relocating residual signals of the reconstructed residual block within the current block; and
relocating the residual signals in the relocation area.

2. The method of claim 1, wherein the current block is square or rectangular, and the arbitrary partitioned blocks are non-square and non-rectangular.

3. The method of claim 1, wherein generating the reconstructed residual block comprises:
generating the reconstructed residual block to be different in size from the current block.

4. The method of claim 1, wherein obtaining the arbitrary partitioning information comprises:
deriving or parsing the arbitrary partitioning information by using a decoded syntax.

5. The method of claim 1, wherein the arbitrary partitioning information represents a line segment corresponding to a boundary between the arbitrary partitioned blocks resulting from bisecting the current block.

6. The method of claim 5, wherein:
the arbitrary partitioning information comprises an angle and a distance of the line segment relative to an origin of the current block; or
the arbitrary partitioning information comprises an index value indicating data obtained by combining the angle and the distance of the line segment.

7. The method of claim 5, wherein determining the relocation area comprises:
determining, among pixels in the current block, pixels located on the boundary and pixels adjacent to the boundary, as the relocation area.

8. The method of claim 1, wherein relocating the residual signals comprises:
among pixels of the current block, excluding pixels in the relocation area and setting remaining pixels in the current block to a predetermined value.

9. A method performed by a video encoding apparatus for transforming arbitrary partitioned blocks of a current block, the method comprising:
obtaining arbitrary partitioning information of the current block, wherein the arbitrary partitioning information represents a partitioning shape of the current block into the arbitrary partitioned blocks;
determining, by using the arbitrary partitioning information, a transform area subject to a transform from the arbitrary partitioned blocks;
generating a residual block by obtaining and two-dimensionally vectorizing residual signals of pixels included in the transform area; and
generating transformed coefficients of the current block by transforming the residual block.

10. The method of claim 9, wherein the current block is square or rectangular, and the arbitrary partitioned blocks are non-square and non-rectangular.

11. The method of claim 9, wherein pixel values in the current block are residual signals obtained by subtracting predicted signals of the current block from original signals of the current block.

12. The method of claim 9, wherein obtaining the arbitrary partitioning information comprises:
deriving or parsing the arbitrary partitioning information by using a syntax signaled from a high level.

13. The method of claim 9, wherein the arbitrary partitioning information represents a line segment corresponding to a boundary between the arbitrary partitioned blocks resulting from bisecting the current block.

14. The method of claim 13, wherein:
the arbitrary partitioning information comprises an angle and a distance of the line segment relative to an origin of the current block; or
the arbitrary partitioning information comprises an index value indicating data obtained by combining the angle and the distance of the line segment.

15. The method of claim 13, wherein determining the transform area comprises:
determining, among pixels in the current block, pixels located on the boundary and pixels adjacent to the boundary, as the transform area.

16. The method of claim 9, wherein generating the transformed coefficients comprises:
making the residual block different in size from the current block.

17. A computer-readable recording medium storing a bitstream generated by a video encoding method for transforming arbitrary partitioned blocks of a current block, the video encoding method comprising:
obtaining arbitrary partitioning information of the current block, wherein the arbitrary partitioning information represents a partitioning shape of the current block into the arbitrary partitioned blocks;
determining, by using the arbitrary partitioning information, a transform area subject to a transform from the arbitrary partitioned blocks;
generating a residual block by obtaining and two-dimensionally vectorizing residual signals of pixels included in the transform area; and
generating transformed coefficients of the current block by transforming the residual block.
